(19) United States
(12) Patent Application Publication
(10) Pub. No.: US 2004/0162866 A1
(43) Pub. Date: Aug. 19, 2004

(54) System and method for producing fast modulated complex lapped transforms

(76) Inventor: Henrique S. Malvar, Sammamish, WA (US)

Correspondence Address: Mark A. Watson, Lyon & Harr, Suite 800, 300 Esplanade Drive, Oxnard, CA, 93030, US

(21) Appl. No.: 10/370,132

(22) Filed: Feb. 19, 2003

(51) Int. Cl. G06F 17/14

(52) U.S. Cl. 708/404

(57) ABSTRACT

A system and method for producing fast modulated complex transforms (MCLTs) provides a fast MCLT generator for computationally efficient derivation of modulated MCLT coefficients from an input signal of one or more dimensions. The fast MCLT generator performs spectral analysis by spectrally decomposing a digital signal at predefined frequencies uniformly distributed over a sampling frequency interval into complex frequency coefficients so that magnitude and phase information at each frequency is immediately available. The fast MCLT generator directly uses fast Fourier transforms (FFTs) without data shuffling in the derivation of MCLT coefficients from an input signal. The MCLT coefficients represent an encoded version of the input signal. Reconstruction of the input signal is accomplished by performing an inverse MCLT operation on the MCLT coefficients.

### BACKGROUND

1. Technical Field

The invention relates to a system for producing modulated complex lapped transforms (MCLTs), and in particular, a system and method for deriving MCLTs without data shuffling by directly using fast Fourier transforms (FFT) followed by butterfly-like stages to derive the MCLTs.

2. Related Art

As is known to those skilled in the art, a modulated complex lapped transform (MCLT) is a cosine-modulated filter bank that maps overlapping blocks of a real-valued signal into complex-valued blocks of transform coefficients. Thus, the MCLT performs a frequency decomposition that is similar to that obtained with the commonly-used discrete Fourier transform (DFT) filter bank.

One significant advantage of the MCLT over DFT filter banks is that unlike the DFT filter bank, the MCLT allows for three simple reconstruction formulas: 1) using all coefficients; 2) using only the cosine coefficients; or 3) using only the sine coefficients. The ability to use any of these three reconstruction formulas provides is useful in a number of signal processing tasks, such as, for example, audio enhancement and encoding systems. For example, a conventional noise reduction module can be implemented in an MCLT domain and, after enhancement, only the cosine coefficients need to be sent to an encoder. In fact, the MCLT cosine coefficients comprise the modulated lapped transform (MLT) coefficients for the same signal, and the MLT is quite popular in audio coding. The MCLT has been used in applications where magnitude-phase decomposition is needed, as well as interfacing to coding systems, such as in audio watermarking and identification.

Conventional MCLT processing is relatively fast, indirectly using fast Fourier Transforms (FFTs). However, before mapping the data into FFTs, such conventional processing requires the use of “data shuffling” to place the data in a format suitable for computation of the MCLT coefficients from an input signal via FFTs. Unfortunately this data shuffling is computationally expensive. Further, conventional MCLT processing is unable to directly use fast Fourier Transforms (FFTs) in computing MCLT coefficients. Because computation of FFTs has been an area of intensive research over the years, there exist many algorithms and systems for fast and efficient computation of FFTs. Therefore, an MCLT algorithm that can make direct use of the FFT, without data shuffling stages, would lead to significant speed savings.

Certain applications require very fast computations of the MCLT for a number of reasons, including a need to accomplish particular signal processing tasks in real-time. For example, multimedia devices and audio processing devices, such as noise reduction devices and echo cancellation devices frequently make use of MCLTs for real-time processing of audio or multimedia signals. Unfortunately, both the need to use data shuffling, and the inability to directly use FFTs in computing MCLTs serves to limit the speed at which MCLT coefficients can be computed. Clearly, a reduction in the amount of time needed to derive MCLTs for a given signal would clearly improve the efficiency and performance of any device which used MCLTs in signal processing tasks. Therefore, a need exists for a system and method for fast and computationally efficient derivation of MCLTs.

### SUMMARY

A system and method for fast derivation of modulated complex lapped transforms (MCLTs) as described herein solves the aforementioned problems, as well as other problems that will become apparent from an understanding of the following description by providing a novel method for accelerating the derivation of MCLTs from an input signal of any dimensionality.

An MCLT spectrally decomposes an input signal at predefined frequencies uniformly distributed over a sampling frequency interval into complex frequency coefficients by mapping a block of M input signal samples into M complex frequency coefficients having both real and imaginary components. These complex frequency components provide magnitude and phase information at each frequency. Further, computing an inverse MCLT from the MCLT allows for perfect reconstruction of an input signal. In addition, the real component of the MCLT is the modulated lapped transform (MLT), which makes for simplified computation of the MLT of a signal whose MCLT is known. This allows for efficient integration with existing multimedia applications, such as acoustic echo cancellation and audio coding.

Unlike conventional schemes for computing an MCLT from an input signal, a “fast MCLT generator,” as described herein, derives MCLT coefficients from an input signal without data shuffling by directly using fast Fourier transforms (FFT) followed by butterfly-like stages involving multiplication of the FFT by complex coefficients for computing the MCLTs. Note that the FFTs are computed from windowed portions of the input signal using a conventional sine window. In one embodiment, the complex coefficients are computed as needed and multiplied with the FFTs as noted above. However, in order to increase overall system performance, in one embodiment, the complex coefficients are pre-computed and stored in a lookup table or list and called as needed. In another embodiment, e.g. for processors with computation units that are faster than memory access units, the coefficients of the butterfly-like stages are computed recursively.

For example, in one embodiment, a system for deriving an MCLT from an input signal begins by computing a complex-valued FFT from a real-valued input signal, followed by performing a complex rotation of the computed FFT. This complex rotation consists of multiplying the FFT coefficients by complex coefficients to produce a sequence of modified complex FFT coefficients. The actual MCLT coefficients are then produced by summing sequential pairs of the modified complex FFT coefficients. Further, because the complex FFT coefficients are summed, the resulting MCLT coefficients include both real and imaginary components. These MCLT coefficients then represent an encoded output of the input signal. Note that decoding this encoded output signal is accomplished by performing an inverse MCLT operation, thereby reconstructing the input signal.

In view of the preceding discussion, it is clear that the fast MCLT generator described herein is advantageous for use in deriving MCLT coefficients from an input signal. In addition to the just described benefits, other advantages of the fast MCLT generator will become apparent from the detailed description which follows hereinafter when taken in conjunction with the accompanying drawing figures.

### DESCRIPTION OF THE DRAWINGS

The specific features, aspects, and advantages of the present invention will become better understood with regard to the following description, appended claims, and accompanying drawings where:

FIG. 1 is a general system diagram depicting a general-purpose computing device constituting an exemplary system for computing modulated complex lapped transform (MCLT) coefficients from an input signal using a fast MCLT generator.

FIG. 2A illustrates an exemplary architectural diagram showing exemplary program modules for using a fast MCLT generator to compute MCLT coefficients from an input signal.

FIG. 2B illustrates an exemplary architectural diagram showing exemplary program modules for using a fast MCLT generator to reproduce an input signal from MCLT coefficients.

FIG. 3A illustrates a flow diagram showing steps for computing MCLT coefficients from an input signal.

FIG. 3B is a general flowgraph illustrating computation of MCLT coefficients from a set of input samples.

FIG. 4 illustrates an exemplary system flow diagram for using the fast MCLT generator to derive an MCLT from an input signal.

FIG. 5 is a general block diagram of a full-band adaptive filter.

FIG. 6 is a general block diagram of a frequency-domain MCLT-based adaptive filter in accordance with the fast MCLT generator described herein.

FIG. 7 is a block diagram of a working example of the adaptive filer of FIG. 6 embodied in the form of an acoustic echo cancellation device.

FIG. 8 is a general block diagram of an acoustic echo cancellation device with MCLT-based adaptive filters in accordance with the fast MCLT generator described herein.

### DETAILED DESCRIPTION OF THE PREFERRED EMBODIMENTS

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 Exemplary Operating Environment:

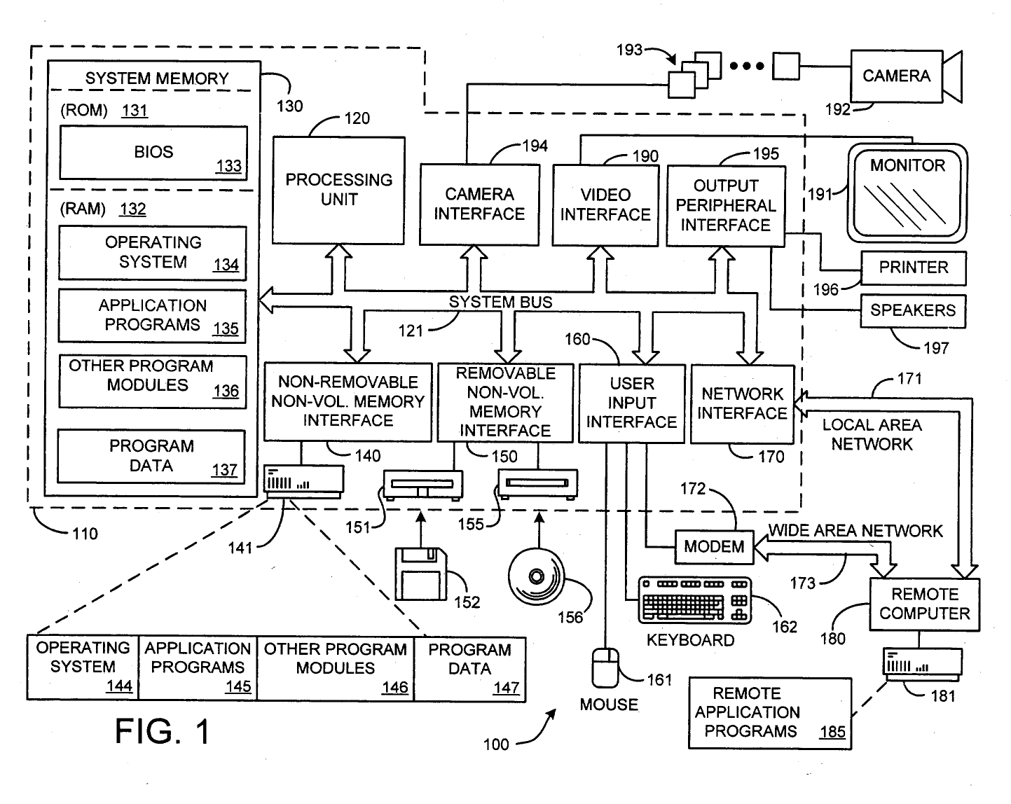

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general-purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media.

The aforementioned term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

Further, the computer 110 may also include, as an input device, a camera 192 (such as a digital/electronic still or video camera, or film/photographic scanner) capable of capturing a sequence of images 193. Further, while just one camera 192 is depicted, multiple cameras could be included as input devices to the computer 110. The use of multiple cameras provides the capability to capture multiple views of an image simultaneously or sequentially, to capture three-dimensional or depth images, or to capture panoramic images of a scene. The images 193 from the one or more cameras 192 are input into the computer 110 via an appropriate camera interface 194. This interface is connected to the system bus 121, thereby allowing the images 193 to be routed to and stored in the RAM 132, or any of the other aforementioned data storage devices associated with the computer 110. However, it is noted that image data can be input into the computer 110 from any of the aforementioned computer-readable media as well, without requiring the use of a camera 192.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying use of a fast MCLT generator.

2.0 Introduction:

As is known to those skilled in the art, a modulated complex lapped transform is basically a cosine-modulated filter bank that maps overlapping blocks of a real-valued signal into complex-valued blocks of transform coefficients. The fast MCLT generator described herein provides a computationally efficient system for short-time spectral decomposition of signals with explicit magnitude and phase information. Further, as with conventional MCLT coefficients, the fast MCLT generator described herein allows for perfect signal reconstruction from decomposed signals. For instance, the fast MCLT generator can use sine functions at defined frequencies and phases to generate an additional orthogonal decomposition. The defined frequencies and phases are preferably the same that the modulated lapped transform (MLT) basis functions use for cosine modulation of a particular window function with certain properties.

The fast MCLT generator described herein is easily integrated with conventional MLT-based systems. For example, once the MCLT of a signal has been computed, its MLT is obtained simply by discarding the imaginary parts of the MCLT. The fast MCLT generator can use both the cosine and sine modulating functions for producing a frame decomposition with desirable properties. Further, the cosine and sine modulations can be used to compute the real and imaginary parts of a transform that has all the magnitude/phase properties of the short-time Fourier transform, while allowing for perfect signal reconstruction. Consequently, the novel the fast MCLT generator of the present invention can be used in applications such as high-fidelity audio coding, adaptive filtering, acoustic echo cancellation, noise reduction, or any other application where high-fidelity signal reconstruction is required.

2.1 System Overview:

The fast MCLT generator, as described herein, provides a system and method for deriving MCLT coefficients from an input signal. In general,,the fast MCLT generator operates by first computing an FFT from a block of input signal samples. Once the FFT has been computed, the FFT coefficients are multiplied by complex coefficients and added to an adjacent FFT which has also been multiplied by a complex coefficients which are a function of the window used to compute the FFT. As described in further detail below, this complex coefficient multiplication is a rotation operation. Following this rotation operation, adjacent the complex FFT coefficients are added together to produce MCLT coefficients.

2.2 System Architecture:

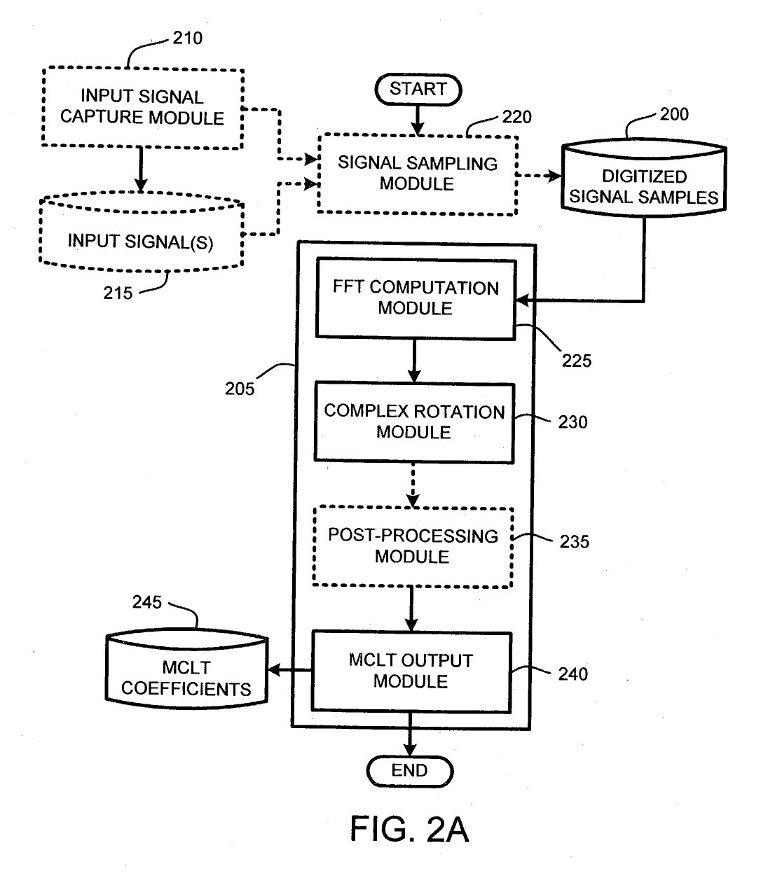

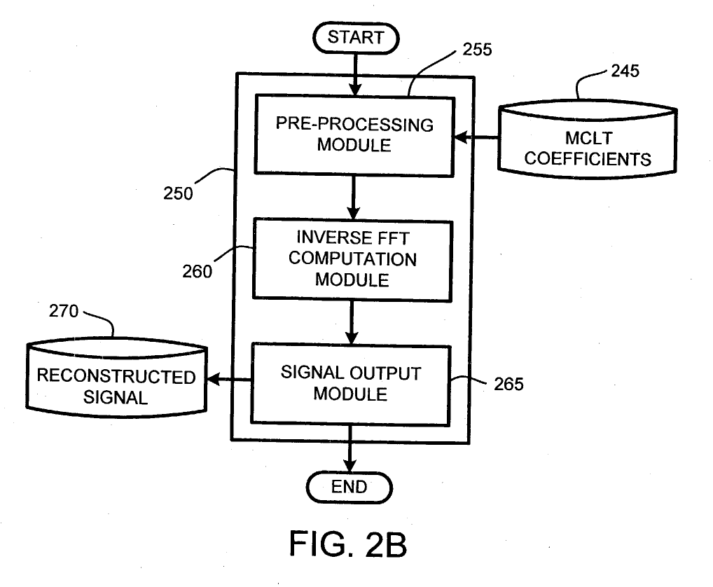

The processes generally summarized above are illustrated by the general system diagram of FIG. 2A. In particular, the system diagram of FIG. 2A illustrates the interrelationships between program modules for computing an MCLT using the fast MCLT generator described herein. It should be noted that the boxes and interconnections between boxes that are represented by broken or dashed lines in FIG. 2A represent alternate embodiments of MCLT derivation methods described herein, and that any or all of these alternate embodiments, as described below, may be used in combination with other alternate embodiments that are described throughout this document.

In particular, as illustrated by FIG. 2A, a system and method for computing MCLTs using the fast MCLT generator begins by providing a set of digitized signal samples 200 to an FFT computation module 225. Note that the digitized signal samples can be obtained by any of a number of conventional means. For example, in one embodiment, a stored input signal 215, of any dimensionality, is provided to a signal sampling module 220 which samples the input signal 215 to provide the digitized signal samples 200. Note that sample length is preferably a power of two, such as, for example, 128, 256, 4096, etc. Choosing a power of two for sample size allows for more efficient use of FFTs in ultimately computing the MCLT coefficients from the digitized signal samples 200. As is known to those skilled in the art, the selection of sample block size is typically a function of the signal being analyzed. However, values in the range of 256 to 4096 typically work well.

In one embodiment, an input signal capture module 210 is first used to read or capture an input signal from any of a variety of signal sources, i.e., a signal broadcast, a signal file, or other signal input source. The input signal capture module 210 then either stores the signal 215 for later processing, or, alternately, provides the signal directly to the signal sampling module 220 for extracting digitized signal samples 200 for use in deriving MCLT coefficients.

In any case, once the digitized signal samples 200 are available, the FFT computation module 225 computes a real-input, complex output FFT of length-2M from 2M input samples, producing M+1 distinct FFT coefficients U(0) to U(M). Again, as noted above, each input sample block size M is preferably, but not necessarily a power of two in size, so as to maximize the efficiency of the FFT computations. Once the FFT coefficients have been computed by the FFT computation module 225, a complex rotation module 230 is used to multiply each FFT coefficient by a corresponding complex coefficient, and once multiplied, to add pairs of adjacent multiplied FFTs together to produce corresponding MCLT coefficients.

At this point, in one embodiment, a post processing module 235 is optionally used to process MCLT coefficients using any of a number of MCLT processing techniques, such as for example, frequency domain filtering. Such post processing of MCLT coefficients is well-known to those skilled in the art. An MCLT output module 240 then outputs the MCLT coefficients 245 to be used as desired, regardless of whether post processing was first applied to the MCLT coefficients.

As illustrated by FIG. 2B, the MCLT coefficients 245 can then be used to reconstruct the original input signal. Reconstruction of the original input signal from the MCLT coefficients is a trivial matter. In, general, such reconstruction is accomplished by providing the MCLT coefficients 245 to an inverse FFT computation module 260 via a preprocessing module 255 which is used in the same manner as the post processing module 235 illustrated in FIG. 2A for processing MCLT coefficients using any of a number of MCLT processing techniques. The inverse FFT module 260 then simply computes an inverse FFT from the preprocessed MCLT coefficients 245 to produce a number of signal samples. A signal output module 265 then recombines these signal samples to produce a reconstructed signal 270 which is then stored or used in any manner desired.

For example, because the input signal can be reconstructed from the MCLT coefficients, the MCLT coefficients clearly represent an encoded version of the input signal. Thus, in one embodiment, compression of that input signal can be easily achieved by scalar or vector quantization of the MCLT coefficients.

3.0 Operation Overview:

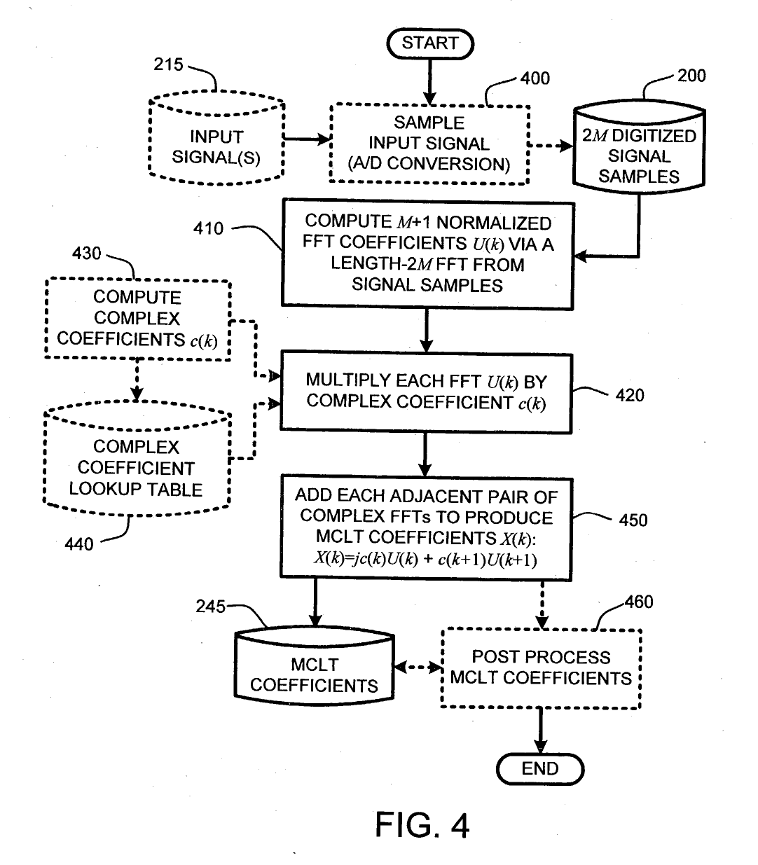

The system and method described herein computing an MCLT using the fast MCLT generator is applicable to any of a number of well known signal processing tasks, including, for example, adaptive filters and acoustic echo cancellation (AEC). In general, the above-described program modules are employed in the fast MCLT generator for automatically computing an MCLT from an input signal. This process is depicted in the flow diagram of FIG. 4 following a detailed operational discussion of exemplary methods for implementing the aforementioned programs modules.

In general, the fast MCLT generator derives MCLT coefficients from an input signal, or input signal samples. The following sections describe in detail the operational elements for implementing the fast MCLT generator using the processes summarized above. Note that for purposes of explanation, the following description assumes a 1-dimensional signal, such as, for example, an audio signal, an electrocardiogram signal, an acceleration data signal, etc. However, the fast MCLT generator described herein is fully capable of processing a signal of any desired dimensionality. For example, an image signal representing a 2-dimensional picture or set of image pixels would represent a 2-dimensional signal, etc.

In particular, rather than processing a signal vector, as is the case with the 1-dimensional signal described below, the processing described below would simply involve the use of a 2-dimensional or higher signal matrix wherein the rows of the matrix would be processed followed by processing of the columns of the matrix. The computation of FFTs for higher dimensional signals is well understood by those skilled in the art. Consequently, because the 1-dimensional signal illustration provided below is easily extensible to the higher dimensional signal types, the processing of such higher dimensional signal types will not be described in further detail herein.

3.1 Modulated Complex Lapped Transforms:

By way of background, as is well known to those skilled in the art, a length-M MCLT of a length-2M signal block {x(n)} can be defined as illustrated by Equation 1:

$$X ( k ) = {\sum }_{n = 0}^{2 M - 1} x ( n ) p ( n , k ) \qquad Equation 1$$

where a frequency index k varies from 0 to M−1, n is a time index, and p(n,k) are analysis basis functions, defined by p(n,k)=p_{c}(n,k)−jpₛ(n,k), where j=\sqrt{−1} and

$${p}_{c} ( n , k ) = \sqrt{\frac{2}{M}} h ( n ) cos [ ( n + \frac{M + 1}{2} ) ( k + \frac{1}{2} ) \frac{π}{M} ] \\ {p}_{s} ( n , k ) = \sqrt{\frac{2}{M}} h ( n ) sin [ ( n + \frac{M + 1}{2} ) ( k + \frac{1}{2} ) \frac{π}{M} ] \qquad Equation 2$$

where h(n) is the window function. Another way to describe this concept is by simply writing X(k)=X_{c}(k)−jXₛ(k), with

$${X}_{c} ( k ) = {\sum }_{n = 0}^{2 M - 1} x ( n ) {p}_{c} ( n , k ) , {X}_{s} ( k ) = {\sum }_{n = 0}^{2 M - 1} x ( n ) {p}_{s} ( n , k ) \qquad Equation 3$$

Further, note that X_{c}(k), the cosine components of X(k), are the modulated lapped transform (MLT) of the input signal x(n). The window h(n) can be designed in many ways, with one common choice being

h(n)=−sin [(n+½)p/2M].

Also, as known to those skilled in the art, an inverse MCLT can be computed via the reconstruction formula:

$$y ( n ) = {β}_{c} {\sum }_{k = 0}^{M - 1} {X}_{c} ( k ) {p}_{c} ( n , k ) + {β}_{s} {\sum }_{k = 0}^{M - 1} {X}_{s} ( k ) {p}_{s} ( n , k ) \qquad Equation 4$$

where the coefficients β_{c} and βₛ can be chosen in several ways. For example, one conventional scheme proposes: 1) β_{c}=1 and βₛ=0 (cosine only); 2) β_{c}=0 and βₛ=1 (sine only); and 3) β_{c}=βₛ=½. It is easy to see that Equation 4 works for any β_{c} and βₛ such that β_{c}+βₛ=1. For example, given the choice β_{c}=βₛ=½ (corresponding to seeing the MCLT as an overcomplete signal decomposition whose basis functions form a tight frame with a frame gain of two), Equation 4 leads to y(n)=x(n) h²(n), wherein there is no time-domain aliasing. However, given b_{c}≠bₛ, then the reconstructed signal, y(n), for a single block also contains time-aliased versions of x(n). In all cases, after overlapping of the reconstructed blocks, the reconstructed signal y(n) matches the original signal x(n), because the overlapped squared windows add to one and any time-domain aliasing terms, if present, are canceled.

As suggested by one conventional scheme, one efficient way to compute the MCLT is to borrow from conventional fast MLT algorithms. In particular, the cosine component of the MCLT can be computed via an MLT algorithm that is based on a type-IV discrete cosine transform (DCT-IV), while the sine component of the MCLT can be computed via a slightly modified MLT algorithm based on a type-IV discrete sine transform (DST-IV). Note that both the DCT-IV and the DST-IV are well known to those skilled in the art, and will not be described in further detail herein. Given this suggested use of the DCT-IV and the DST-IV in the computation of the MCLT, the computational complexity of the MCLT would be exactly twice that of the MLT. In particular, the computational complexity would consist of M(log₂M+5) multiplications and M(3log₂M+3) additions, for any M that is a power of two. However, one conventional implementation of the MCLT shares some of the windowing operations between the DCT-IV and the DST-IV transforms, thereby reducing the computational complexity to M(log₂M+4) multiplications and M(3log₂M+2) additions.

3.2 Fast Modulated Complex Lapped Transforms:

One disadvantage of the MCLT scheme described above is that it does not use a fast Fourier transform (FFT) directly. In fact, as described above, it maps the MCLT into DCT-IVs, which are then computed via length-M/2 complex FFTs. However, as known to those skilled in the art, this process requires data shuffling, which increases the computational complexity of the MCLT.

In contrast, the novel fast MCLT generator described herein uses a single length-2M real FFT, with no data shuffling, thereby significantly reducing the computational complexity of the MCLT. The fast MCLT generator described herein starts by assuming that M is even, and that a window function h(n) used will sum to a constant when squared. One such window h(n) is the common sine window, which can be written as a sum of two complex exponentials as illustrated by Equation 5:

$$\begin{matrix}h ( n ) = - sin [ ( n + \frac{1}{2} ) \frac{π}{2 M} ] \\ = \frac{j}{2} [ {W}_{8 M} ( 2 n + 1 ) - {W}_{8 M} ( - 2 n - 1 ) ]\end{matrix} \qquad Equation 5$$

where W_{M}(r) [symbol] exp(−j2πr/M). Further, this same notation can be used to map Equations 1-3 produce Equation 6:

$$X ( k ) = \sqrt{\frac{2}{M}} {\sum }_{n = 0}^{2 M - 1} x ( n ) h ( n ) {W}_{8 M} [ ( 2 k + 1 ) ( 2 n + M + 1 ) ] \qquad Equation 6$$

Combining Equations 5 and 6 then serves to produce Equation 7:

X(k)=jc(k)U(k)+c(k+1)U(k+1) Equation 7

where

$$\begin{matrix}c ( k ) {=}^{△} {W}_{8} ( 2 k + 1 ) {W}_{4 M} ( k ) , and \\ U ( k ) {=}^{△} \sqrt{\frac{1}{2 M}} {\sum }_{n = 0}^{2 M - 1} x ( n ) {W}_{2 M} ( kn )\end{matrix} \qquad Equation 8$$

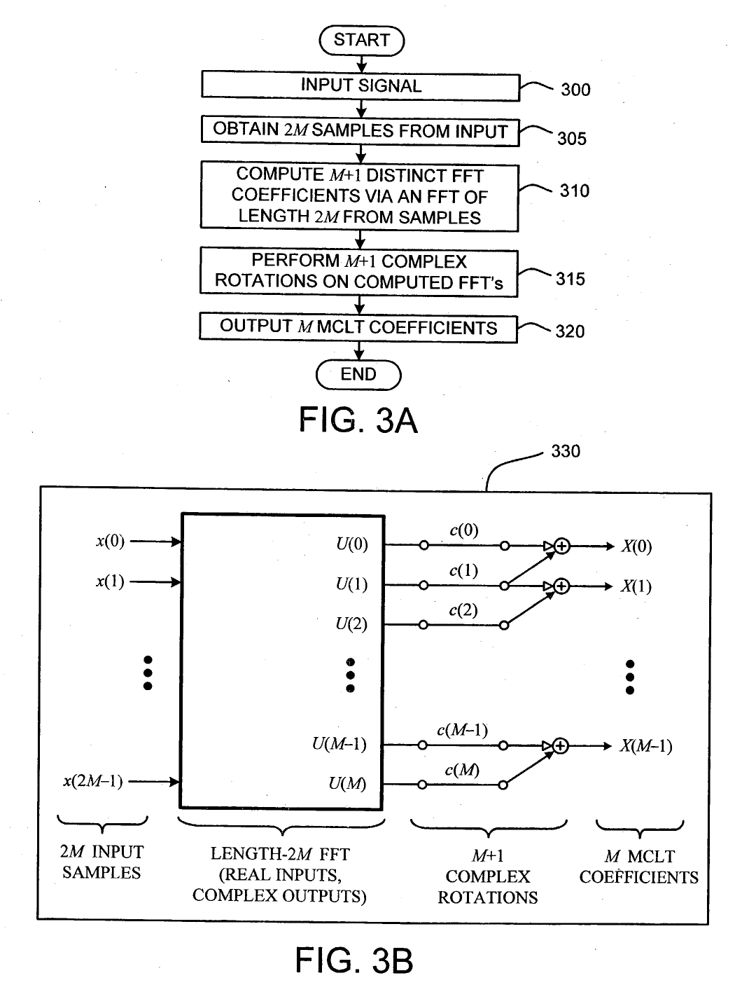

Note that U(k) is a normalized 2M-point FFT of the input block x(n). Consequently, it is clear from Equations 7 and 8 that the MCLT X(k) can be obtained by first computing the FFT U(k) and then performing additional operations with the factors c(k), as illustrated by FIG. 3B. The coefficients c(k) satisfy |c(k)|=1, thus they are rotation operations. This guarantees good numerical properties of MCLT calculation such that rounding errors will have a minimal influence in the final result.

The processes described above are generally illustrated by the flow diagram of FIG. 3A and FIG. 3B. In particular, FIG. 3A illustrates a flow diagram showing steps for computing MCLT coefficients from an input signal, while FIG. 3B is a general flowgraph that also illustrates computation of MCLT coefficients from a set of input samples.

In particular, as illustrated by FIG. 3A, a signal block of 2M input samples 305 are obtained from an input signal 300 using any conventional sampling method. Again, the signal block of 2M input samples is obtained using a window function h(n). Given these input samples 305, M+1 FFT coefficients are computed directly from the signal block. These FFT coefficients are then used in a complex rotation operation 315 which results in M MCLT coefficients 320.

The steps illustrated by FIG. 3A are more clearly illustrated by the flowgraph of FIG. 3B. In particular, as illustrated by FIG. 3B the fast MCLT generator 330 computes M+1 coefficients U(k) from an input sample block x(n) via a length-2M FFT. Again, as noted above, the input sample block x(n) includes 2M input samples. Once the M+1 FFT coefficients U(k) have been computed, each FFT coefficients U(k) is multiplied by a corresponding complex coefficient c(k). Again, as noted above, these complex coefficients c(k) are a function of the window h(n). Consequently, so long as the window to be used is known in advance, the complex coefficients c(k) can simply be pre-computed and read as needed for multiplication operations. Next, after the aforementioned multiplication operation, pairs of sequential or adjacent FFT coefficients are added together, with the result being the MCLT coefficients. As noted above, and as illustrated by the flowgraph of FIG. 3B, these multiplication and addition operations are basically complex rotation operations.

Note that the fast MCLT generator described in this Section is for the computation of the MCLT of a single block of the input signal. For each subsequent block of the signal, a new FFT of length 2M must be computed. Note that even though the first half of the new block is identical to the second half of the previous block, this property cannot be used to speed up the FFT computation.

3.3 Inverse Modulated Complex Lapped Transforms:

Once the MCLT has been computed as described above, computing an inverse MCLT allows for reconstruction of the original signal. Further, as is known to those skilled in the art, an MCLT may be further processed prior to computing an inverse MCLT. Such processing includes any of a number of signal processing algorithms, such as, for example, noise filtering and acoustic echo cancellation (AEC), to name only two.

In general, the corresponding inverse MCLT algorithm can be easily inferred from the flowgraph of FIG. 3B. For example, a simple derivation can be obtained via matrix notation. Specifically, let xₘ=[X(0) . . . X(M−1)]^{T} be a vector with the MCLT coefficients, and let x=[x(0) . . . x(2M−1)]^{T} be an input data vector, where the superscript T denotes transposition. Given these conditions, Equation 3 can be rewritten in matrix notation as xₘ=x_{c}−jxₛ, where x_{c}=P_{c}^{T}x and xₛ=Pₛ^{T}x. The entries of the matrices P_{c} and Pₛ are given by Equations 1 and 2. Calling W the normalized discrete Fourier transform (DFT) matrix and u=[U(0) . . . U(2M−1)]^{T} the DFT of x, it can be concluded from Equation 8 that u=W^{*T}x (where the asterisk denotes complex conjugate).

Therefore, according to Equations 7 and 8, x_{c}=D_{c}^{*T}u=D_{c}^{*T}W^{*T}x and xₛ=Dₛ^{*T}u=Dₛ^{*T}W^{*T}x, where the matrices D_{c} and Dₛ are sparse, with at most two nonzero entries in each row. Thus, P_{c}=WD_{c} and Pₛ=WDₛ. Next, from the reconstruction formula provided by Equation 4, y=β_{c}y_{c}+βₛyₛ, where y_{c}=P_{c}x_{c} and yₛ=Pₛxₛ. Given these relationships, it can be seen that y=W[β_{c}D_{c}x_{c}+βₛDₛxₛ]. In other words, the inverse MCLT y is obtained by simply combining the MCLT coefficients x_{c} and xₛ through the sparse operators D_{c} and Dₛ and then applying an inverse normalized FFT operator W.

3.4 Computational Complexity of the Fast MCLT Generator:

As noted above, one of the advantages of the fast MCLT generator illustrated by FIG. 3A and FIG. 3B is that it does not require data shuffling as with conventional MLT and MCLT algorithms. Consequently, the fast MCLT generator reduces execution time in software implementations and simplifies the VLSI chip structure in hardware implementations. Another advantage of the fast MCLT generator is that in one embodiment, the coefficients c(k) are computed recursively, so that tables of rotation coefficients can be avoided. In particular, it can be seen from Equation 8 that c(k)=c(k−1)W_{4M}(M+1), thereby allowing for recursive computation of the coefficients c(k).

In accordance with the preceding discussion, it is clear that the the computational complexity of the fast MCLT generator is that of a length-2M FFT for real inputs, plus the complex rotation operations of Equation 7. Thus, for M equal to a power of two, the length-2M real-input FFT requires M(log₂M−2)+2 multiplications and M(3log₂M−2)+4 additions. Therefore, in addition to the FFT computation, M+1 complex multiplications and M complex additions are performed as illustrated by Equation 7. Each of these complex multiplications can be performed with three multiplications and three additions. Additionally, U(0) and U(M) are real, c(0) and c(M) have identical real and imaginary parts (except for sign), and c(M/2)=W₄(M/2+1), which is either purely real or purely imaginary for M>2. Therefore, the rotations by c(k) take 3M−2 multiplications and 5M−6 additions. Thus, as illustrated by Table 1, the total computational complexity of the fast MCLT generator is M(log₂M+1) multiplications and M(3log₂M+3)−2 additions.

Consequently, as illustrated by Table 1 the fast MCLT generator requires substantially fewer computations than existing MCLT computation schemes. In particular, one MCLT computation scheme (Scheme 1) avoids data shuffling, but requires complex multiplications both before and after computing an FFT, and thus a complex-input/complex-output FFT must be used. As a result, the computational complexity of that scheme is approximately doubled. However, as noted above, the fast MCLT generator described herein not only avoids data shuffling, but also reduces the total complexity when compared to more a more traditional MCLT computation scheme (Scheme 2) which does require data shuffling. In comparison to the MCLT computation of Scheme 2, the fast MCLT generator described herein requires 3M fewer multiplications and M−2 extra additions, for a net savings of 2M+2 operations. In a tested embodiment, the fast MCLT generator was observed to compute MCLT coefficients for a given input signal approximately 50% faster than that of Scheme 1, and approximately 25% faster than that of Scheme 2.

TABLE 1

| | Number of | | Data |
|---|---|---|---|
| Method | multiplications | Number of additions | shuffling? |
| Fast MCLT | M (log₂ M + 1) | M (3 log₂ M + 3) − 2 | No |
| Generator | | | |
| Scheme 1 | M (log₂ M + 4) | M (3 log₂ M + 2) | Yes |
| Scheme 2 | M (2 log₂ M + 3) + 2 | M (6 log₂ M + 3) + 4 | No |

4.0 System Operation:

The program modules described in Section 2.2 with reference to FIG. 2A and 2B, and in view of the detailed description provided in Section 3, with reference to FIGS. 3A and 3B, are employed for automatically deriving MCLTs from an input signal using the fast MCLT generator. This process is depicted in the flow diagram of FIG. 4. It should be noted that the boxes and interconnections between boxes that are represented by broken or dashed lines in FIG. 4 represent alternate embodiments of the present invention, and that any or all of these alternate embodiments, as described below, may be used in combination.

Referring now to FIG. 4 in combination with FIG. 2A, the process can be generally described as a system for deriving MCLT coefficients from an input signal or signal samples of any desired dimensionality. In particular, as illustrated by FIG. 4, a system and method for deriving MCLT coefficients from an input signal begins by providing digitized signal samples 200 for computation of FFTs. As described above, these signal samples 200 can be provided from a set of stored samples, or may be acquired by sampling 400 an input signal 215 using conventional methods.

As described above, given an input sample block of 2M samples 200, M+1 normalized FFT coefficients are computed from a of length-2M FFT 410. Next, each of the FFT coefficients U(k) are multiplied by a corresponding complex coefficient c(k) 420 to produce modified FFT coefficients. In alternate embodiments, these complex coefficients c(k) are either computed recursively 430, as described above, or pre-computed and stored to a lookup table 440 or the like.

Next, each pair of adjacent modified complex FFT coefficients is simply added 450 together to produce a corresponding MCLT coefficient. Note that the combination of the steps of multiplication by a complex coefficient and adding of pairs of sequential or adjacent complex FFTs (420 and 450, respectively) is basically a complex rotation operation.

Once the MCLT coefficients 245 have been computed in the manner described above, they are either stored for later use as desired, or modified by post-processing 460 to achieve a desired signal processing effect. Examples of such signal processing effects include frequency domain filtering and noise reduction, to name only two of many signal processing tasks that can be performed on MCLT coefficients.

5.0 Working Examples:

Two basic working examples are provided below in order to illustrate the application of the fast MCLT generator for use in encoding and decoding an input signal. In particular, the working examples included in this section include: 1) The use of the fast MCLT generator for computing MCLTs for use in an adaptive filter; and 2) The use of the fast MCLT generator for computing MCLTs for use in an acoustic echo cancellation (AEC) system. Note that the configurations described in this section have no special significance. In fact, the types of signals described and types of pre- and post-processing described below were chosen simply for purposes of explanation. Clearly, in view of the preceding discussion, the fast MCLT generator is capable of processing any of a number of signal types, while allowing for any desired pre- or post-processing to be applied to the MCLT coefficients.

5.1 Full Band Adaptive Filter:

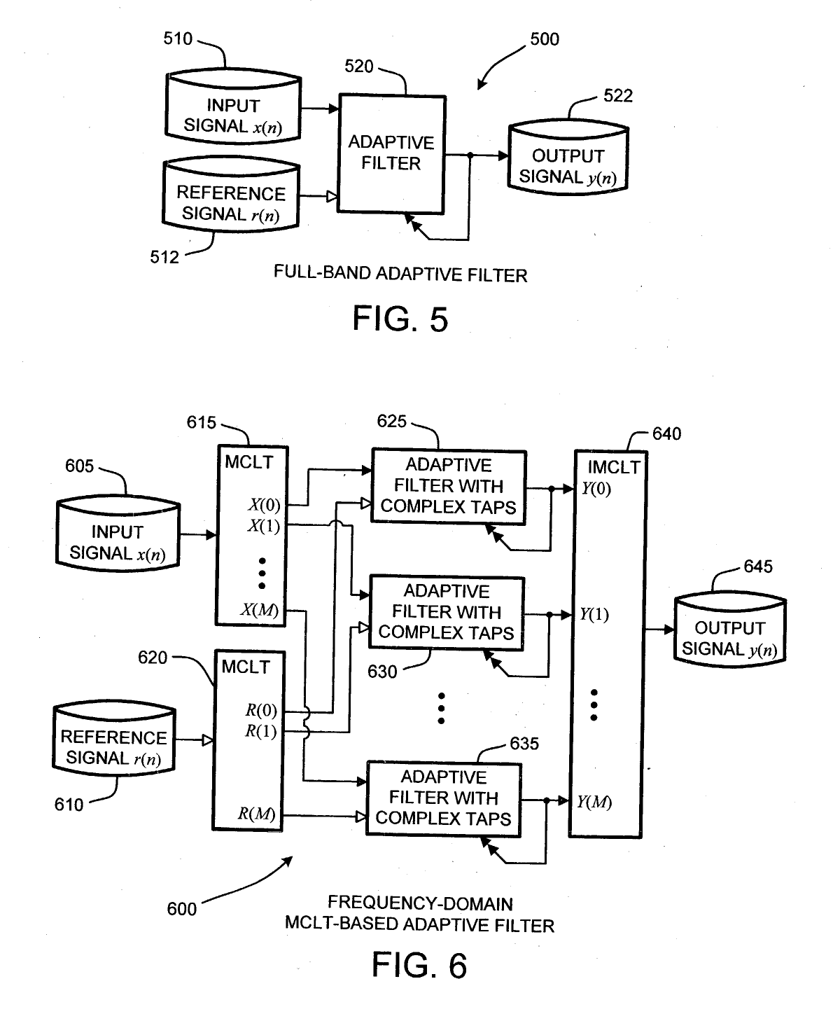

FIG. 5 is a general block diagram of a full-band adaptive filter using an adaptive FIR filtering approach. In general, a filtering system 500, such as a full-band adaptive filtering system, includes an input signal x(n) 510 and reference signal r(n) 512 received by an adaptive filter 520. The adaptive filter produces an output signal y(n) 522, which is sent back into the adaptive filter 520 for providing automatic refinement adjustments to the filtering process until the output signal y(n) approximates as closely as possible the reference signal r(n) 512.

Specifically, the adaptive filter 520 is preferably a filter with time-varying coefficients, which are automatically adjusted such that the output of the filter approximates as closely as possible a prescribed reference signal. If the adaptive filter 520 has a finite impulse response (FIR), the output signal y(n) 522 is computed from the input signal x(n) 510 by Equation 9 as follows:

$$y ( n ) = {\sum }_{l = 0}^{L - 1} {w}_{l} ( n ) x ( n - l ) \qquad Equation 9$$

where L is the length of the filter and {wₗ(n), l=0, 1, . . . , L−1} are the time-varying filter coefficients. The adaptive filter 520 allows the output y(n) 522 to approximate the reference signal r(n) 512 or equivalently, drives an error signal e(n)=r(n)−y(n) as close to zero as possible.

Given an initial setting for the filter coefficient vector wₗ(0) the coefficients can be updated by using a conventional least-mean-square (LMS) algorithm as illustrated by Equation 10:

wₗ(n+1)=wₗ(n)+2μe(n)x(n−1) Equation 10

where μ is a parameter that controls the speed of adaptation. For any coefficient position l, the LMS performs updates as an adaptation rule if the error e(n) has the same sign as the input x(n), i.e. if their product is positive, then |y(n)| is too small, and thus wₗ should be increased. The adaptation rule above corresponds to adjusting the coefficient vector w in the negative direction of the gradient of the error with respect to w, i.e. a steepest descent update.

The adaptive filter of FIG. 5 can be used in many applications where the response of the filter needs to change in view of varying conditions. Examples include modems (to equalize the signal distortions caused by the telephone lines) and acoustic echo cancellers (to remove the feedback from loudspeakers into microphones). If the input signal has a frequency spectrum that contains many peaks and valleys (i.e., if it is heavily “colored”), the parameter μ in the LMS update equation has to be set to a very low value, which reduces the speed of adaptation, i.e., the speed in which the error signal e(n) converges to values near zero. On the other hand, if the input signal has a flat (white) spectrum, the LMS update equation is optimal, in the sense that it will lead to the fastest possible convergence. Such adaptive filters are known to those skilled in the art.

5.2 Frequency-Domain Adaptive Filters:

FIG. 6 is a general block diagram of a frequency-domain MCLT-based adaptive filter in accordance with the present invention. The performance of the LMS adaptive filter of FIG. 5 discussed above can be improved for colored input signals by using the structure of FIG. 6. For instance, the signals can be broken into frequency subbands and an adaptive LMS filter can be performed in each subband, as shown in FIG. 6. Although FIG. 6 depicts the MCLT as the transform operator that performs the frequency decomposition, other transforms could be used, such as a modulated lapped transform (MLT). If real transforms such as the MLT are used, the adaptive filters of each of the subbands have real coefficients. With a complex-valued transform such as the MCLT, the filter coefficients will have complex values.

In general, the frequency-domain adaptive filter 600 of FIG. 6 includes a first MCLT processor 615 for receiving and processing an input signal x(n) 605. The first MCLT processor 615 produces input signal vectors, such as X(0) through X(M). The frequency-domain adaptive filter of FIG. 6 also includes a second MCLT processor 620 for receiving and processing a reference signal r(n) 610. The second MCLT processor 620 produces reference signal vectors, such as R(0) through R(M). Also included in system 600 are a number M+1 of adaptive filters, 625, 630 and 635, for receiving the input signal vectors X(0) through X(M) and the reference signal vectors R(0) through R(M) for producing corrected signal vectors, such as Y(0) through Y(M) and an inverse modulated complex lapped transform processor (IMCLT) 640. The IMCLT 640 receives and processes the corrected signal vectors Y(0) through Y(M) for producing a final output signal y(n) 645 that substantially matches the input signal x(n).

Thus, in the frequency-domain the adaptive filter of FIG. 6, there is an adaptive filter for each subband k. Consequently, the subband signals are modified according to the adaptive filter learning computation. The final output y(n) 645 is obtained by applying an inverse MCLT (IMCLT) on the corrected subband/transform coefficients {Y(k)}. If the original adaptive filter of FIG. 5 had L coefficients, each adaptive filter in FIG. 6 needs only to have L/M coefficients, for the same time span.

Advantages of using the frequency-domain adaptive filter of FIG. 6 include faster convergence, because the signals within each subband are approximately white, even for a heavily colored input. Also, the MCLT-based adaptive filter system of FIG. 6 provides improved error control, because the μ factors for the adaptive filters in each subband can be adjusted independently. Finally, the system illustrated by FIG. 6 has a reduced computational complexity, because of the fast FFT-based algorithms available to compute the transforms.

5.3 Acoustic Echo Cancellation (AEC):

An acoustic echo cancellation (AEC), such as for real-time full-duplex communication systems (for instance, speakerphones and videoconference systems) can be accomplished by building on the MCLT-based adaptive filter of FIG. 6. For example, in a speakerphone system, the AEC can use an adaptive filter that estimates a feedback transfer function from a loudspeaker to a microphone. An estimated echo return is then subtracted from the microphone signal. Simple FIR filters are not ideal in such a case because of the length of the impulse response necessary to obtain a reasonable amount of echo reduction (for a 16 kHz sampling rate and an echo window of 100 ms, a 1,600-point impulse response is needed). With subband adaptive filtering, the long FIR full-band filter is replaced by a collection of short FIR filters, one for each subband.

A critically sampled filter bank such as the MLT can be used for adaptive filtering, but uncancelled aliasing due to subband processing may limit the amount of echo reduction to 10 dB or less. Performance can be improved by using cross-filters among neighboring subbands, but the extra degrees of freedom in such adaptive cross-filters usually slows down convergence significantly. However, with an MLCT-based AEC, subband acoustic echo cancellation (AEC) can be performed without cross-filters. Each subband can be processed by a short FIR filter with complex taps, as shown in FIG. 6. With a large number of subbands, the subband signals are essentially white, and so each adaptive filter can be adjusted via the normalized LMS computation.

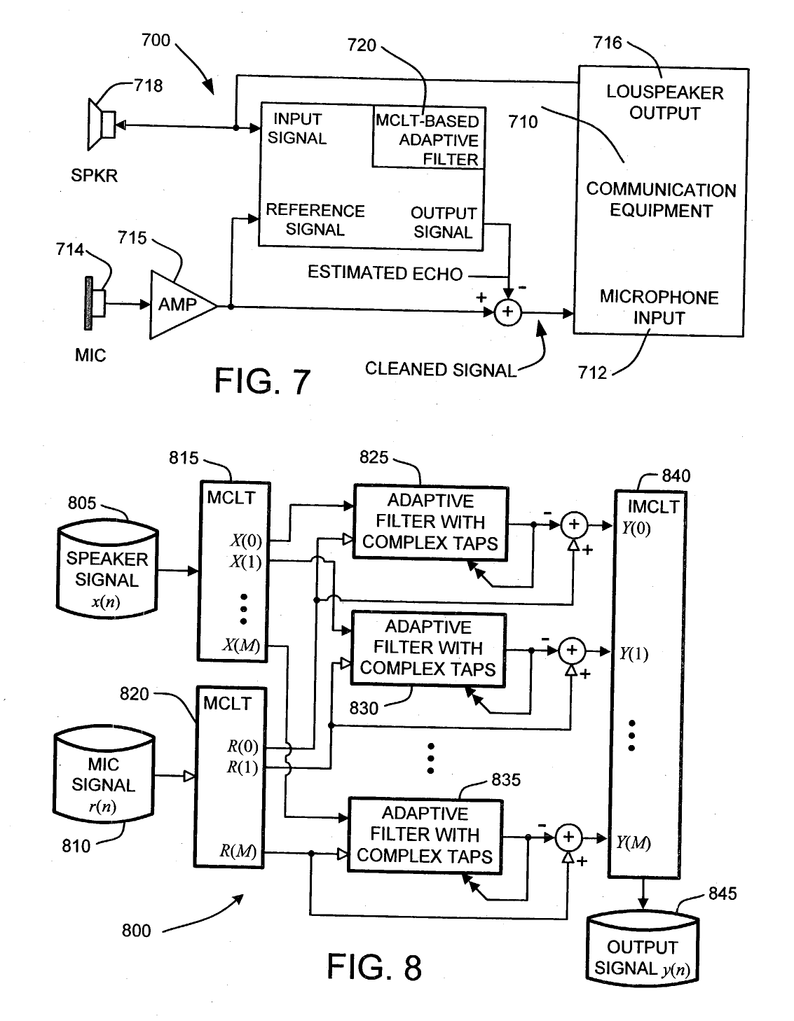

For example, FIG. 7 provides a block diagram of a speakerphone working example of the MCLT-based adaptive filter of FIG. 6 in the form of an acoustic echo cancellation device. The speakerphone system 700 of FIG. 7 includes communication equipment 710 comprising microphone input signals 712 received from a microphone 714. Note that the microphone input signals 712 may be amplified by an amplifier 715. The communication equipment 710 further includes speaker output signals 716 that are transmitted to a speaker 718. The system 700 also includes a filter 720, such as the MCLT-based adaptive filter discussed above with reference to FIG. 6, for receiving input signals produced by the speaker 718 and reference signals received by the microphone 714.

In typical speakerphone systems, the local microphone not only captures audio signals intended to be transmitted (such as voice signals of a local person), it also captures audio signals that are being attenuated at the local loudspeaker (such as voice signals from a remote person's transmission) as feedback. However, unless the speaker feedback is cancelled, that feedback signal is sent back to the remote person. Consequently, the remote person will hear an echo of his or her own voice transmitted to the local person.

To solve this problem, the adaptive filter described herein includes an MCLT-based adaptive filter (see FIG. 6) for processing and filtering the input and reference signals for producing an output signal with information indicating the estimated echo portion of the signal. The estimated echo portion of the output signal is removed or canceled and a resulting clean output signal is sent to the microphone input of the communication equipment 710. Consequently, after an initial audio signal is sent through the system 700, subsequent audio signals with feedback or echoes produced by the loudspeaker 718 are canceled by the adaptive filter 720 before the microphone input is received.

Since the input to the adaptive filter 720 is the signal from the speaker 718 and the reference input is the signal from the microphone 714, the output of the adaptive filter will be a good estimate of the portion of the microphone signal that is dependent on the loudspeaker signal, which is precisely the echo. When the echo is subtracted from the signal of the microphone 714, as shown in FIG. 7, only the part of the microphone signal that is not correlated with the loudspeaker signal will remain. The remaining part (which is the “cleaned” microphone signal 712 in FIG. 7) corresponds to the other local sounds, such as the voice of the person speaking and other ambient sounds.

Given this introduction, FIG. 8 provides a general block diagram of an acoustic echo cancellation (AEC) device 800 with MCLT-based adaptive filters in accordance with fast MCLT generator described above. In general, referring to FIGS. 6-7 along with FIG. 8, the AEC 800 of FIG. 8 includes a first MCLT processor 815 for receiving and processing a loudspeaker signal as an input signal x(n) 805 for producing input signal vectors X(0) through X(M) and a second MCLT processor 820 for receiving and processing a microphone signal as a reference signal r(n) 810 for producing reference signal vectors R(0) through R(M).

Also included in system 800 are a number M+1 of adaptive filters, 825, 830 and 835, for receiving the input signal vectors X(0) through X(M) and the reference signal vectors R(0) through R(M). The adaptive filters, 825, 830 and 835, estimate the echo within the signals, which are then combined with the reference signals for canceling the echoes and producing cleaned and corrected signal vectors, such as Y(0) through Y(M). An inverse modulated complex lapped transform processor (IMCLT) 840 then receives and processes the corrected signal vectors Y(0) through Y(M), which have MCLT coefficients without echo, for producing a final output signal y(n) 845 with the echo canceled.

Subtraction of the estimated echo from the microphone signal is preferably performed for each subband, resulting in a set of subband signals Y(k) with the echo substantially removed.

The AEC and spectral subtraction can be combined using a single MLCT decomposition. For example, spectral subtraction can be applied to the subband signals immediately after the AEC adaptive filters. If the resulting signal is to be encoded by an MLT-based codec, then the MLT coefficients for the audio codec can be obtained by simply taking the real part of the outputs of the spectral subtraction. Therefore, only a single transformation step with the MCLT is necessary to perform simultaneous signal enhancement and coding.

If the waveform y(n) corresponding to the echo-cancelled subband signals Y(k) in FIG. 8 is desired, then an inverse modulated complex transform (IMCLT) can be performed on Y(k), as shown in FIG. 6. However, if the signals are to be encoded with an MLT-based coder/decoder (codec), such as MSAudio, then y(n) need not be computed since a codec can work directly with the Y(k) subband/transform coefficients.

One advantage of using the MCLT-based adaptive filters is that the MCLT uses short windows, which leads to low processing delay. Another advantage is that the MCLT allows for perfect signal reconstruction. Also, integrating an MCLT adaptive filter with an MLT-based processing system (for example, an audio codec) is very easy, since the MLT is obtained directly as the real part of the MCLT. Further, for a given number of subbands M (which is also the block size), a windowed Fourier transform decomposes the signal into M/2+1 distinct subbands. The fast MCLT generator described herein breaks the signal into M+1 subbands, and so it provides essentially twice the frequency resolution. Therefore, an MCLT-based adaptive filter will converge faster, because narrower subbands tend to have a flatter spectrum.

As noted above, the preceding examples were provided only as examples of possible applications of the fast MCLT generator. These examples are not intended to limit either the scope or potential applications of the fast MCLT generator. Clearly, as will be appreciated by those skilled in the art, MCLT coefficients, and thus the fast MCLT generator are useful for any of a number of signal processing tasks.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for deriving a modulated complex lapped transform (MCLT) from an input signal, comprising:
computing FFT coefficients from an input signal;
performing a complex rotation of the computed FFT coefficients; and
providing results of the complex rotation as MCLT coefficients derived from the input signal, and wherein the MCLT coefficients represent an encoded output of the input signal.

2. The system of claim 1 wherein the complex rotation comprises:
multiplying the FFT coefficients by complex coefficients to produce sequential modified complex FFT coefficients; and
summing each pair of sequential modified complex FFT coefficients to produce the MCLT coefficients, said MCLT coefficients comprising real and imaginary components.

3. The system of claim 1, wherein compression of the input signal is achieved by at least one of scalar and vector quantization of the MCLT coefficients.

4. The system of claim 1, further comprising processing the encoded output by at least one of transmitting the output, storing the output, compressing the output, enhancing the output, and filtering the output.

5. The system of claim 4, wherein filtering the output comprises reducing interference within the input signal with a noise reducer.

6. The system of claim 4, wherein filtering the output comprises reducing interference within the input signal with an echo canceller.

7. A computer-implemented process for computing a spatial transform of an input signal, comprising using a general purpose computing device to:
receive an input signal and compute FFT coefficients from the input signal;
multiply the FFT coefficients by complex coefficients to produce sequential complex FFT coefficients; and
sum each pair of sequential complex FFT coefficients to produce a modulated complex lapped transform having real and imaginary transform coefficients as an output signal.

8. The computer-implemented process of claim 7, wherein the output signal is produced as a vector with the transform coefficients corresponding to the input signal.

9. The computer-implemented process of claim 7, further comprising processing the output signal by at least one of transmitting the output, storing the output, compressing the output, enhancing the output, and filtering the output.

10. The computer-implemented process of claim 7, wherein the window function is a sine window.

11. A method for performing spectral analysis by receiving an input signal represented by a sample block comprising:
spectrally decomposing an input signal at predefined frequencies uniformly distributed over a sampling frequency interval into complex frequency coefficients so that magnitude and phase information at each frequency is immediately available, by:
decomposing the input signal into FFT coefficients at predefined frequencies uniformly distributed over the sampling frequency interval;
multiplying the FFT coefficients by complex coefficients to produce modified FFT coefficients; and
summing pairs comprising two sequential modified FFT coefficients to produce an output signal comprising a modulated complex lapped transform consisting of the complex frequency coefficients.

12. The method of claim 11, further comprising processing the output signal by any of:
transmitting the output signal;
storing the output signal;
compressing the output signal;
enhancing the output signal; and
filtering the output signal.

13. A computer-readable medium having computer-executable instructions for computing a spatial transform of a multidimensional signal, said computer executable instructions comprising:
receiving an input signal;
computing FFT coefficients from the input signal;
performing a complex rotation operation on the FFT coefficients; and
outputting results of the complex rotation operation as a modulated complex lapped transform, said modulated complex lapped transform forming an encoded output signal.

14. The computer-readable medium of claim 13 wherein the complex rotation operation comprises:
multiplying the FFT coefficients by complex coefficients to produce sequential modified FFT coefficients; and
summing sequential pairs of the modified FFT coefficients to produce the modulated complex lapped transform, said modulated complex lapped transform including real and imaginary transform coefficients.

15. The computer-readable medium of claim 13, wherein an inverse MCLT operation is applied to the encoded output signal to reproduce the input signal.

16. The computer-readable medium of claim 13, further comprising computer-executable instructions for processing the encoded output signal by one or more of:
transmitting the output;
storing the output;
compressing the output; and
filtering the output.
